(19) United States
(12) Patent Application Publication
(10) Pub. No.: US 2012/0237791 A1
(43) Pub. Date: Sep. 20, 2012

(54) HEAT CONDUCTIVE COMPOSITE SUBSTRATE HAVING HEAT DISSIPATION PROPERTIES AND MANUFACTURING METHOD THEREOF

(75) Inventor: San-Bao Lin, Zhongli City (TW)

(73) Assignee: Enlight Corporation, Zhongli City (TW)

(21) Appl. No.: 13/349,241

(22) Filed: Jan. 12, 2012

(30) Foreign Application Priority Data
Mar. 17, 2011 (TW) 100109181

(51) Int. Cl. B32B 15/04; B32B 3/02; C25D 15/00

(52) U.S. Cl. 428/634; 428/457; 205/109; 428/68

(57) ABSTRACT

The present invention discloses a heat conductive composite substrate having heat dissipation properties and a manufacturing method thereof. The heat conductive composite substrate comprises a heat dissipation substrate and a metal diamond composite layer physically disposed on the heat dissipation substrate for passing heat energy to the heat dissipation substrate. The metal diamond composite layer is a growth substance including at least one kind metal, and the growth substance is distributed with plural diamond particles therein.

### RELATED APPLICATIONS

This application claims priority to Taiwanese Application Serial Number 100109181, filed Mar. 17, 2011, which is herein incorporated by reference. To the extent appropriate, a claim of priority is made to the above-disclosed application.

### BACKGROUND

1. Technical Field

The present invention relates to an electronic component, more particularly to an electronic component having heat dissipation properties.

2. Description of Related Art

An electronic component, e.g., a CPU component or LED component, generates high temperatures during operation. Moreover, the greater the efficiency of the electronic component, the greater the temperature it will generate during operation. However, when an electronic component reaches a certain high temperature, the electronic component itself may be damaged or malfunction. As a result, a heat dissipation component, e.g., a heat conductive adhesive or transparent insulation adhesive, is often provided between the electronic component and a substrate.

For example, if a high power LED component is not equipped with a heat dissipation design which matches the heat generation rate, the brightness of the LED may decay and the service life of the LED may be shortened. Existing packaging techniques for an LED component include die bonding, wire bonding followed by direct dispensing, auto encapsulation, and molding.

Conventional die bonding involves utilizing a heat conductive adhesive or transparent insulation adhesive to fasten a chip of an LED component on a substrate of a package member. The heat generated by the LED component is transmitted from the interior of the LED component to the substrate, then through the heat conductive adhesive or transparent insulation adhesive to the substrate of the package member. With the increased light emitting power and operating temperature, the heat conductive adhesive or transparent insulation adhesive may no longer be capable of managing the significant heat transmission. Hence, light attenuation and overheating of the component may result to thereby cause the component to malfunction.

### SUMMARY

One aspect of the present invention is to provide a heat conductive composite substrate having heat dissipation properties and a manufacturing method thereof, so as to effectively dissipate heat.

The present invention is to provide a heat conductive composite substrate having heat dissipation properties. The heat conductive composite substrate comprises a heat dissipation substrate and a metal diamond composite layer. The metal diamond composite layer is physically disposed on a surface of the heat dissipation substrate, so as to transmit heat energy from the metal diamond composite layer to the heat dissipation substrate, wherein the metal diamond composite layer is a growth substance consisted of at least a kind of metal, and the growth substance is distributed with plural diamond particles therein.

The metal diamond composite layer not only directly transmits heat energy to the heat dissipation substrate, but at the same time transversally transmits the heat energy in the metal diamond composite layer, and evenly guides the heat energy to each region of the heat dissipation substrate, thereby increasing the heat dissipation efficiency of the heat dissipation substrate.

Compared to conventional configurations, the present invention utilizes the metal diamond composite layer on the heat dissipation substrate to effectively, rapidly and evenly transmit the heat energy received by the metal diamond composite layer to the heat dissipation substrate. As a result, the service life of a heat generation unit is increased and the performance stability of the heat generation unit is enhanced, ultimately making the end product more competitive in the marketplace. In addition, the heat conductive composite substrate provided by the present invention allows for operation in an environment with a higher temperature, thereby avoiding the need to install additional heat dissipation/protection mechanisms to thereby lower production cost.

### BRIEF DESCRIPTION OF THE DRAWINGS

The present invention will be apparent to those skilled in the art by reading the following detailed description of a preferred embodiment thereof, with reference to the attached drawings, in which:

FIG. 1A is a schematic view showing a heat conductive composite substrate having heat dissipation properties according to one embodiment of the present invention;

FIG. 1B is a schematic view showing the heat conductive composite substrate having heat dissipation properties in a state in contact with a heat generation unit, in which the transmission of heat energy from the heat generation unit is indicated by arrows;

FIG. 2 is a flow chart showing a manufacturing method of a heat conductive composite substrate according to the preset invention;

FIG. 3 is a schematic enlarged view showing a metal diamond composite layer of the heat conductive composite substrate having heat dissipation properties according to the present invention;

FIG. 4 is a schematic view showing the heat conductive composite substrate having heat dissipation properties according to an alternative embodiment of the present invention;

FIG. 5 is a schematic view showing the heat conductive composite substrate having heat dissipation properties according to another alternative embodiment of the present invention; and

FIG. 6 is a schematic view showing the heat conductive composite substrate having heat dissipation properties according to still another alternative embodiment of the present invention.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

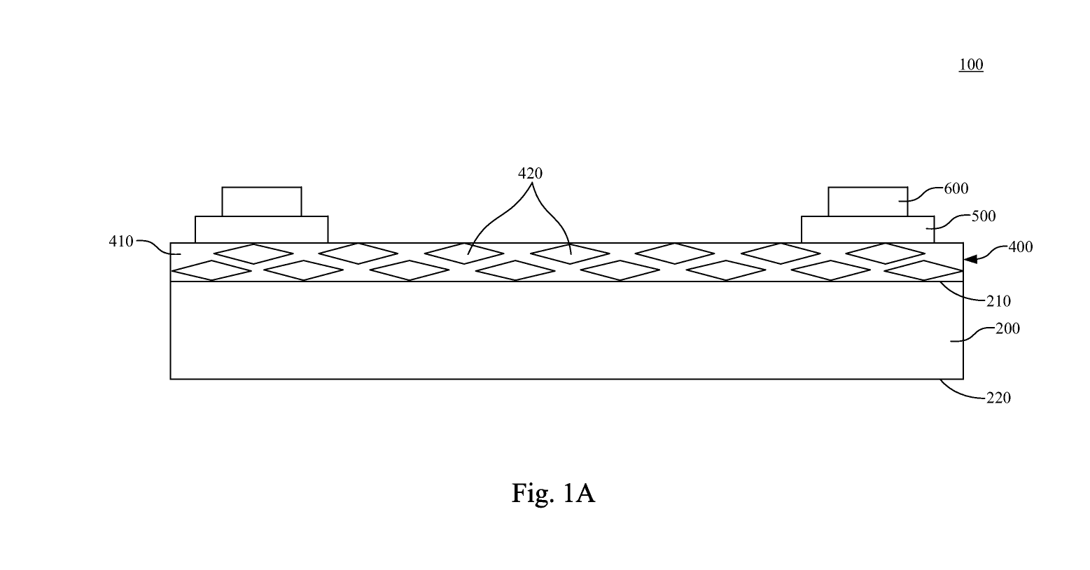

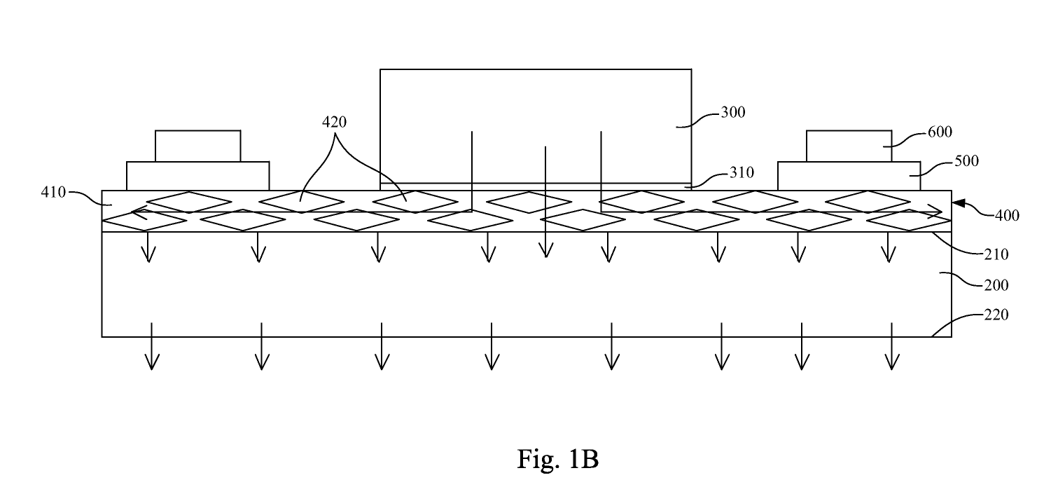

FIG. 1A is a schematic view showing a heat conductive composite substrate having heat dissipation properties according to one embodiment of the present invention.

The present invention provides a heat conductive composite substrate having heat dissipation properties 100 which comprises a heat dissipation substrate 200 and a metal diamond composite layer 400. The metal diamond composite layer 400 is disposed on a surface of the heat dissipation substrate 200 for transmitting heat energy to the heat dissipation substrate 200. The metal diamond composite layer 400 is a growth substance 410 consisted of at least a metal contained in the heat dissipation substrate 200, and the growth substance 410 is distributed with plural diamond particles 420 therein. Compared to the conventional heat conductive adhesive or transparent insulation adhesive, the metal diamond composite layer 400 provided by the present invention can more rapidly transmit high temperatures generated by a heat generation unit (to be described below) to the heat dissipation substrate 200, so that subsequent heat dissipation performed by the heat dissipation substrate 200 can be more effectively realized.

According to one embodiment of the present invention, the metal diamond composite layer 400 has a high degree of electric conductivity, and the growth substance 410 thereof comprises a metal material consisted of a single kind of metal, such as silver, copper, gold, nickel, aluminum, tin, chromium, titanium, or iron. Alternatively, the metal material of the growth substance 410 thereof can also be an alloy consisted of two or more of metals, such as silver, copper, gold, nickel, aluminum, tin, chromium, titanium and iron. The metal material of the metal diamond composite layer 400 is a metal material having a high degree of heat conductivity, such as silver (429 W/mK), copper (398 W/mK), gold (319 W/mK), nickel (89 W/mK), aluminum (170 W/mK) or an alloy thereof.

The diamond particles 420 (also referred to as diamond powder) are capable of more rapidly transmitting heat energy than any other material. In room temperature, the heat conductivity of diamond, which is about 2000 W/mK, is 5 times greater than the heat conductivity of copper, which is about 401 W/mK, and 8 times greater than that of aluminum, which is approximately 250 W/mK. In addition, the heat diffusion coefficient of diamond, which is roughly 12.7 cm2/sec, is 11 times greater than the heat diffusion coefficient of copper, which is about 1.17 cm2/sec, or the heat diffusion coefficient of aluminum, which is approximately 0.971 cm2/sec. The characteristic of diamond which enables this material to only transmit heat energy without restoring heat makes diamond an ideal material for heat dissipation.

According to another embodiment of the present invention, the diamond particles 420 are diamond or industrial diamond (also referred to as cubic zirconia). The structure of the diamond particles 420 is not limited to a single crystal or multiple crystals. In some embodiments, the structure of the diamond particles 420 is that of a single crystal.

According to another embodiment of the present invention, the heat dissipation substrate 200 is a metal, non-metal or semiconductor substrate. Any metal, non-metal or semiconductor material exhibiting a heat dissipation effect can be used in the heat dissipation substrate 200, and any examples provided herein should not limit the scope of the present invention. In this embodiment, the heat dissipation substrate 200 includes a metal, e.g., copper or aluminum, or an alloy consisted of two or more metals, e.g., an alloy of aluminum or copper or a composition thereof, or an electroplated member thereof. The non-metal material of the heat dissipation substrate 200 includes any known ceramic material, e.g., silicide, oxide, boride, carbide or a combination thereof. The semiconductor material of the heat dissipation substrate 200 may be, for example, germanium, germanium arsenic, or silicon.

FIG. 1B is a schematic view showing the heat conductive composite substrate having heat dissipation properties in a state in contact with a heat generation unit, in which the transmission of heat energy from the heat generation unit is indicated arrows.

The heat conductive composite substrate 100 can be installed on a heat generation unit 300. The heat generation unit 300 includes a semiconductor component which generates high temperatures during operation, such as an LED die, a die of a process chip, etc. The heat conductive composite substrate 100 installed with the heat generation unit 300 can be, for example, an LED component or a process component (e.g., a CPU or GPU).

The heat generation unit 300 is fixed on the surface of the metal diamond composite layer 400 opposite to the heat dissipation substrate 200 through an adhesive layer 310. During operation, the heat generation unit 300 generates a large amount of high-temperature heat energy. The metal diamond composite layer 400 can rapidly transmit the generated heat energy to the heat dissipation substrate 200, so that subsequent heat dissipation performed by the heat dissipation substrate 200 can be more effectively realized.

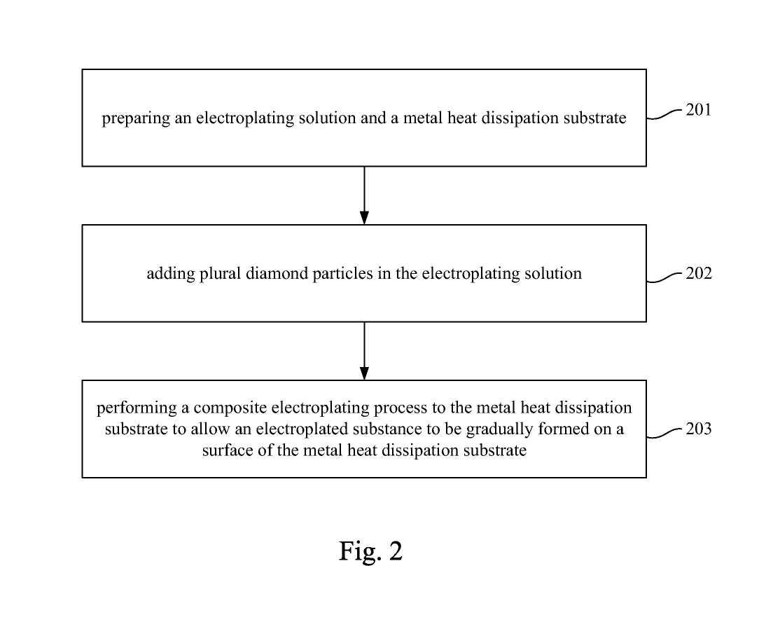

Reference is now made to FIG. 1A and FIG. 2. FIG. 2 is a flow chart showing a manufacturing method of a heat conductive composite substrate according to the preset invention.

The present invention provides a manufacturing method of a heat conductive composite substrate. The manufacturing method comprises the steps as outlined below.

First, in Step (201), an electroplating solution and a heat dissipation substrate are prepared. The electroplating solution may be, for example, an electroplating solution containing the metals as described above. The electroplating solution may include an acid, alkaline or cyanide formula. The heat dissipation substrate may be the substrate disclosed in the embodiments described above.

Next, in Step (202), plural diamond particles 420 are added into the electroplating solution. According to one embodiment, the diamond particles 420 can be stirred in the electroplating solution to thereby be evenly distributed in the electroplating solution.

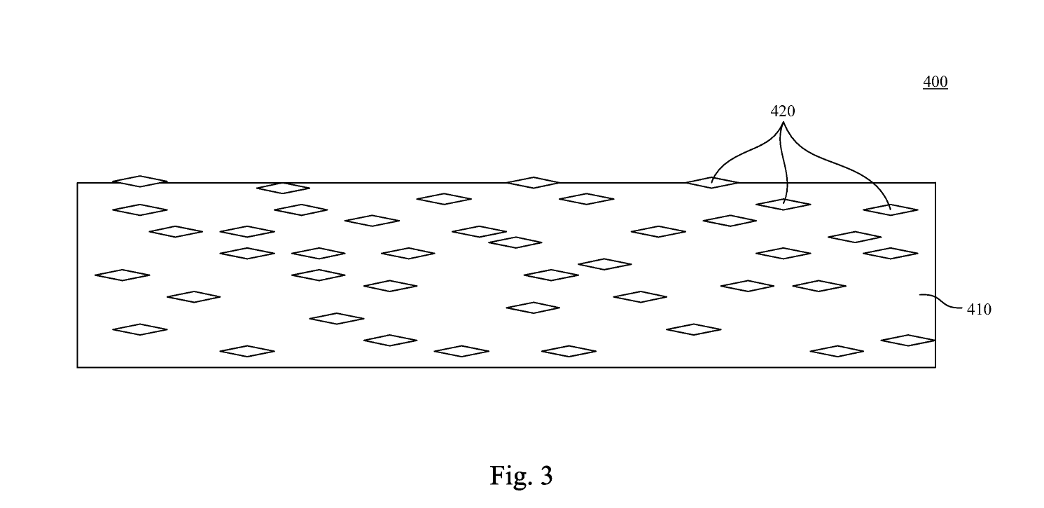

Finally, in Step (203), a composite electroplating process is performed with respect to the heat dissipation substrate 200. Through operation of van der Waals forces, an electroplated growth substance 410 (e.g., in a layered-like shape or block-like shape) is gradually formed on the heat dissipation substrate 200, and at the same time, the diamond particles 420 are dispersed and adhered on or in the electroplated growth substance 410 (as shown in FIG. 3), thereby obtaining a metal diamond composite layer 400. It is to be noted that the composite electroplating process of the present invention is performed in a normal temperature and normal pressure environment. For example, the temperature may be about 200 degrees Celsius (but not exceed 200 degrees Celsius), and the pressure under one bar.

In addition, the electroplating process of the present invention can involve a composite electroplating method or a composite electroless plating method.

In composite electroplating, a metal electrode-position method is utilized to allow one or more insoluble solid particles to be evenly enclosed in a metal substrate. Composite electroplating requires an electroplating solution with greater electroplating efficiency in order to facilitate disposing of the particles into the electroplated layer at a high deposition rate. In composite electroplating, a stirring process is crucial, with the performance and quality of the metal electroplated layer being greatly dependent on the manner in which stirring is performed. Stirring is undertaken to maintain the maximum concentration of effective solid particles in the electroplating solution. Composite electroplating involves adding second-phase particles or fibers in the substrate of a metal electroplated layer. The second-phase particles can be ceramic powders (e.g., aluminum oxide or silicon carbide), graphite, Teflon®, diamond, etc.

Electroless plating is also referred to as electroless metal composites and polyalloys, chemical plating or autocatalyticplating. In electroless plating, metal ions in a water solution in a controlled environment are processed using a chemical reduction process without the need for electric power to realize plating on a substrate. Hence, electroless plating is applicable to non-conductive materials, such as plastic. For example, composite electroless plating involves co-depositing a metal and micro particles of diamond, ceramics, chromium carbide, silicon carbide or aluminum oxide in an electroless plating bath to obtain a surface which is harder, more wear-resistant and has a greater lubricating property.

The thickness of the metal diamond composite layer 400 can be varied according to actual needs. In some embodiments, the thickness of the metal diamond composite layer 400 may be 0.1 um˜200 um. In addition, the metal diamond composite layer 400 of the present invention allows for the omission of an interface having adhering properties, such as a glue material.

With composite electroplating, the metal diamond composite layer 400 can be mass-produced and made to a large surface, thereby lowering production costs.

In addition to adding diamond particles in the electroplating solution, according to another embodiment of the present invention, silicon carbide (SiC, 280 W/mK) can also be provided. Therefore, in a composite copper electroplating process performed with respect to the heat dissipation substrate 200, while the produced copper has a reduced compactness, an additive can be provided for enhancing flatness and compactness and increasing the heat conductivity thereof.

The present invention further discloses several alternatives to better illustrate the technical characteristics of the present invention.

Referring to FIG. 1B, in one alternative of the embodiment described above, the heat dissipation substrate 200 has a first surface 210 and a second surface 220 opposite to each other. The metal diamond composite layer 400 is disposed on the first surface 210 of the heat dissipation substrate 200, and is in physical contact with the heat dissipation substrate 200. Because an electric insulation treatment is performed with respect to the surface of the heat generation unit 300, which is in contact with the metal diamond composite layer 400, the heat generation unit 300 and the metal diamond composite layer 400 are electrically insulated. Moreover, the surface of the metal diamond composite layer 400 opposite to the heat dissipation substrate 200 is provided with an insulation layer 500 and an electric conductive pattern 600 in this sequence. The electric conductive pattern 600 is electrically connected to the heat generation unit 300 through wires (not shown). The insulation layer 500 is disposed between the electric conductive pattern 600 and the metal diamond composite layer 400. When the heat dissipation substrate 200 is electrically conductive, the insulation layer 500 is used for electrically insulating the electric conductive pattern 600 and the metal diamond composite layer 400. The insulation layer 500 can be polyimide (PI), AL2O3, SiO2, Si3N4, diamond-like carbon (DLC) or TiO2.

In addition, according to another optional arrangement, the metal diamond composite layer 400 is completely disposed on the first surface 210 of the heat dissipation substrate 200, so the contact surfaces of the metal diamond composite layer 400 and the first surface 210 of the heat dissipation substrate 200 have the same area. Through such a configuration, when the heat generation unit 300 generates heat energy during operation (especially high temperature heat energy), the metal diamond composite layer 400 not only directly transmits the heat energy generated by the heat generation unit 300 to the heat dissipation substrate 200, but at the same time, transversally transmits the heat energy in the metal diamond composite layer 400, and evenly guides the heat energy to each region of the heat dissipation substrate 200, thereby increasing the heat dissipation efficiency of the heat dissipation substrate 200.

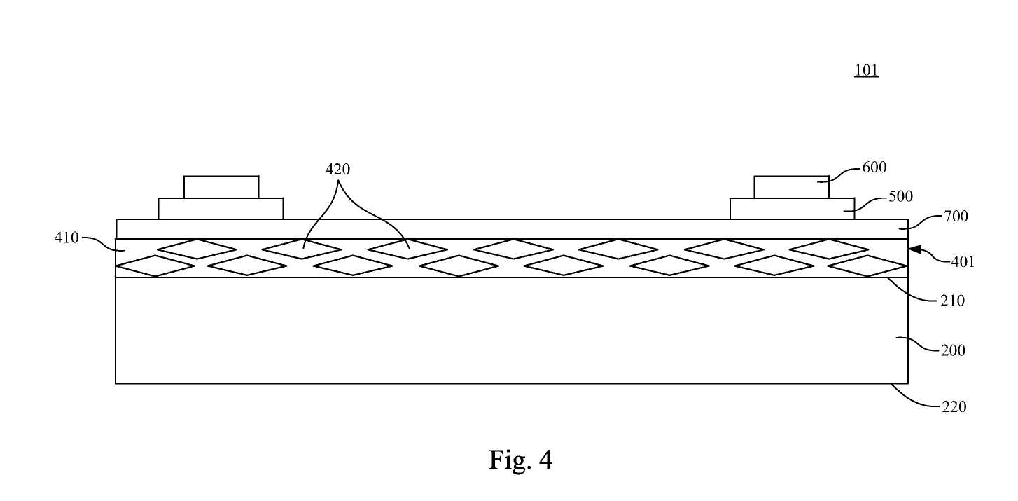

FIG. 3 is a schematic enlarged view showing the metal diamond composite layer of the heat conductive composite substrate having heat dissipation properties according to the present invention, and FIG. 4 is a schematic view showing the heat conductive composite substrate having heat dissipation properties according to an alternative embodiment of the present invention.

With reference to FIG. 3, even though the diamond particles 420 are evenly distributed in the growth substance 410, some diamond particles 420 may still protrude from the surface of the growth substance 410, which causes the surface of the metal diamond composite layer 401 to be uneven. In an alternative embodiment, with reference to FIG. 4, the surface of the metal diamond composite layer 401 opposite to the heat dissipation substrate 200 is provided with a metal layer 700. One surface of the metal layer 700 is in physical contact with the metal diamond composite layer 401, and the other surface thereof may be used for placing of the heat generation unit 300 thereon. Because an electric insulation treatment is performed with respect to the heat generation unit 300, the heat generation unit 300 and the metal layer 700 are electrically insulated.

The metal layer 700 can be made of a single kind of metal, such as silver, copper, gold, nickel, aluminum, tin, chromium, titanium, or iron, or an alloy consisted of two or more of metal materials, such as silver, copper, gold, nickel, aluminum, tin, chromium, titanium and iron. In this embodiment, the metal layer 700 comprises a metal material having high heat conductivity, such as silver (429 W/mK), copper (398 W/mK), gold (319 W/mK), nickel (89 W/mK), aluminum (170 W/mK) or an alloy thereof.

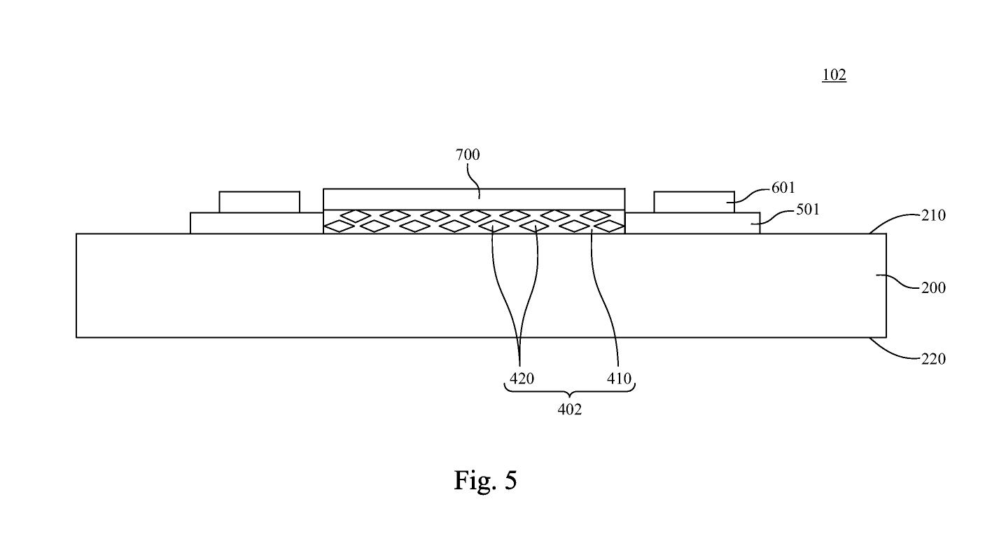

FIG. 5 is a schematic view showing the heat conductive composite substrate having heat dissipation properties according to another embodiment of the present invention.

In this alternative embodiment, the metal diamond composite layer 402 is partially covered on the heat dissipation substrate 200, so the area of the metal diamond composite layer 402 is smaller than that of the heat dissipation substrate 200. The metal layer 700 is disposed on the upper surface of the metal diamond composite layer 402, so the contact surfaces of the metal diamond composite layer 402 and the metal layer 700 have the same area.

In addition, the first surface 210 of the heat dissipation substrate 200 is provided with an insulation layer 501 and an electric conductive pattern 601 in this sequence. The electric conductive pattern 601 is electrically connected to the heat generation unit 300 through wires (not shown). The insulation layer 501 is disposed between the electric conductive pattern 601 and the heat dissipation substrate 200. When the heat dissipation substrate 200 is electrically conductive, the insulation layer 501 is used for electrically insulating the electric conductive pattern 601 and the heat dissipation substrate 200. The insulation layer 501 can be Polyimide (PI), AL2O3, SiO2, Si3N4, diamond-like carbon (DLC) or TiO2.

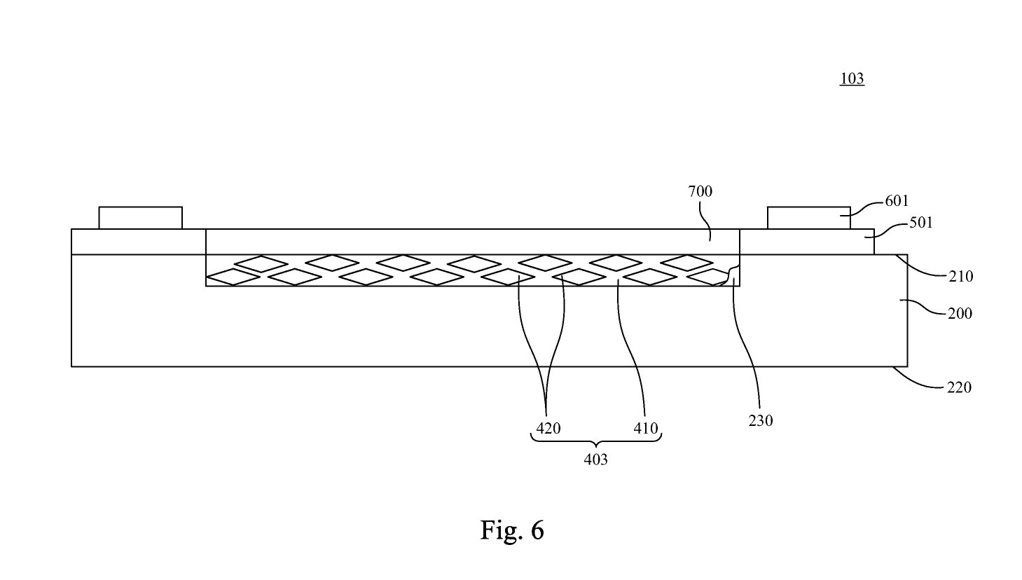

FIG. 6 is a schematic view showing the heat conductive composite substrate having heat dissipation properties according to still another embodiment of the present invention. In this alternative embodiment, the first surface 210 of the heat dissipation substrate 200 is formed with a recess portion 230 in which a metal diamond composite layer 403 can be fully disposed. The metal diamond composite layer 403 in the recess portion 230 is in physical contact with the metal layer 700, and the metal diamond composite layer 403 and the metal layer 700 can have the same or different area.

In addition, the first surface 210 of the heat dissipation substrate 200 is provided with the insulation layer 501 and the electric conductive pattern 601 in this sequence. The electric conductive pattern 601 is electrically connected to the heat generation unit 300 through wires (not shown). The insulation layer 501 is disposed between the electric conductive pattern 601 and the heat dissipation substrate 200. When the heat dissipation substrate 200 is electrically conductive, the insulation layer 501 is used for electrically insulating the electric conductive pattern 601 and the heat dissipation substrate 200. The insulation layer 501 can be polyimide (PI), AL2O3, SiO2, Si3N4, diamond-like carbon (DLC) or TiO2.

Through such a configuration, at least three surfaces of the metal diamond composite layer 403 in the recess portion 230 are in physical contact with the heat dissipation substrate 200. As a result, the metal diamond composite layer 403 can directly transmit heat energy to the heat dissipation substrate 200, and also, the portion of the metal heat dissipation 200 in physical contact with two lateral surfaces of the metal diamond composite layer 403 can also assist in transversally transmitting the high temperature heat energy generated by the heat generation unit 300 to the heat dissipation substrate 200, thereby further increasing the heat dissipation efficiency of the heat dissipation substrate 200.

Although the present invention has been described with reference to the preferred embodiments thereof, it is apparent to those skilled in the art that a variety of modifications and changes may be made without departing from the scope of the present invention which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A heat conductive composite substrate having heat dissipation properties, comprising:
a heat dissipation substrate; and
a metal diamond composite layer physically disposed on a surface of the heat dissipation substrate for transmitting heat energy to the heat dissipation substrate, wherein the metal diamond composite layer is a growth substance comprising at least one kind of metal, and the growth substance is distributed with plural diamond particles therein.

2. The heat conductive composite substrate having heat dissipation properties according to claim 1, wherein the at least one kind of metal is selected from a group consisting of silver, copper, gold, nickel, aluminum, tin, chromium, titanium, iron and a combination thereof.

3. The heat conductive composite substrate having heat dissipation properties according to claim 1, wherein the metal diamond composite layer and the heat dissipation substrate have the same area.

4. The heat conductive composite substrate having heat dissipation properties according to claim 1 further comprising:
a metal layer physically disposed on a surface of the metal diamond composite layer opposite to the heat dissipation substrate.

5. The heat conductive composite substrate having heat dissipation properties according to claim 4, wherein the metal diamond composite layer and the metal layer have the same area.

6. The heat conductive composite substrate having heat dissipation properties according to claim 1, wherein the heat dissipation substrate is formed with a recess portion, and the metal diamond composite layer is fully filled in the recess portion.

7. The heat conductive composite substrate having heat dissipation properties according to claim 1, wherein the heat dissipation substrate is a solid metal substrate having properties of electric conductivity or a substrate having metal plated films on surfaces thereof.

8. The heat conductive composite substrate having heat dissipation properties according to claim 7, wherein the growth substance is an electroplated growth substance formed by composite electroplating or composite electroless plating.

9. A manufacturing method of a heat conductive composite substrate, comprising:
preparing an electroplating solution and a heat dissipation substrate;
adding plural diamond particles in the electroplating solution; and
performing an electroplating process with respect to the heat dissipation substrate to allow an electroplated growth substance to be gradually formed on a surface of the heat dissipation substrate.

10. The manufacturing method of a heat conductive composite substrate according to claim 9, wherein the electroplating process is composite electroplating or composite electroless plating.
